(19) United States
(12) Patent Application Publication
(10) Pub. No.: US 2014/0071240 A1
(43) Pub. Date: Mar. 13, 2014

(54) FREE SPACE DETECTION SYSTEM AND METHOD FOR A VEHICLE USING STEREO VISION

(71) Applicants: Yu-Sung Chen, Changhua County (TW); Yu-Sheng Liao, Changhua County (TW); Jia-Xiu Liu, Changhua County (TW)

(72) Inventors: Yu-Sung Chen, Changhua County (TW); Yu-Sheng Liao, Changhua County (TW); Jia-Xiu Liu, Changhua County (TW)

(73) Assignee: Automotive Research & Testing Center, Changhua County (TW)

(21) Appl. No.: 13/610,351

(22) Filed: Sep. 11, 2012

(51) Int. Cl. H04N 7/18; H04N 13/02

(52) U.S. Cl. 348/46; 348/E13.074; 348/E07.085

(57) ABSTRACT

In free space detection system and method for a vehicle, left and right images captured from the vehicle environment in a direction of travel of the vehicle are transformed to obtain a depth image with disparity values. The depth image is transformed to obtain a road function and an occupancy grid map. A cost estimation value corresponding to each disparity value on the same image column in a detecting area of the occupancy grid map is estimated using a cost function and the road function such that initial boundary disparity values each defined by one disparity value on the same image column whose the cost estimation value is maximum are optimized to obtain optimized boundary disparity values by which a free space is determined.

### BACKGROUND OF THE INVENTION

1. Field of the Invention

The invention relates to obstacle detection, and more particularly to a system and method for detecting a travelable area in a road plane using stereo vision.

2. Description of the Related Art

In order to ensure safe driving of a vehicle, techniques directed to detection of an obstacle have been developed. For example, a laser is used as a parking sensor to detect a travelable distance. The following are some techniques related to obstacle detection.

A conventional obstacle detection apparatus and method are known from U.S. Pat. No. 6,801,244, in which a left image input by a left camera is transformed using each of transformation parameters such that a plurality of transformed left images from a view point of a second camera are generated. The transformed left images are compared with a right image input by a right camera for each area consisting of pixels. A coincidence degree of each area between each transformed left image and the right image is calculated such that an obstacle area consisting of areas each having a coincidence degree below a threshold is detected from the right image. In this case, calculation burden for comparison between the transformed left images and the right image for each area is relatively high. In addition, in case an inappropriate threshold is set, the obstacle may not be detected at high speed. Moreover, many obstacles with intensity, color or texture similar to the road may not be detected.

Therefore, improvements may be made to the above techniques.

### SUMMARY OF THE INVENTION

Therefore, an object of the present invention is to provide a system and method for detecting a free space in a direction of travel of a vehicle that can overcome the aforesaid drawbacks of the prior art.

According to one aspect of the present invention, there is provided a system for detecting a free space in a direction of travel of a vehicle. The system of the present invention comprises:

an image capturing unit including left and right image capturers adapted to be spacedly loaded on the vehicle for capturing respectively left and right images from the vehicle environment in the direction of travel of the vehicle; and

a signal processing unit connected electrically to the image capturing unit for receiving the left and right images therefrom, the signal processing unit being operable to

transforming the left and right images captured by the first and second image capturing units to obtain a three-dimensional depth image that includes X×Y pixels, where X represents the number of the pixels in an image column direction, and Y represents the number of the pixels in an image row direction, each of the pixels having an individual disparity value,

transferring the three-dimensional depth image into two-dimensional image data relative to image row and the disparity so as to generate a road function based on the two-dimensional image data,

transforming the three-dimensional depth image into an occupancy grid map relative to disparity and image column,

determining, based on a travel condition of the vehicle, a detecting area of the occupancy grid map to be detected,

estimating a cost estimation value corresponding to each of the disparity values on the same image column in the detecting area of the occupancy grid map using a cost function and the road function, and defining one of the disparity values on the same image column in the detecting area of the occupancy grid map whose the cost estimation value is maximum as an initial boundary disparity value for a corresponding one of all image columns in the detecting area of the occupancy grid map, and

optimizing the initial boundary disparity values for all the image columns in the detecting area of the occupancy grid map using an optimized boundary estimation function so as to obtain optimized boundary disparity values corresponding respectively to the initial boundary disparity values, and determining the free space in an image plane based on the optimized boundary disparity values using the road function.

According to another aspect of the present invention, there is provided a method of detecting a free space in a direction of travel of a vehicle. The method of the present invention comprises the steps of:

a) capturing respectively left and right images from the vehicle environment in the direction of travel of the vehicle;

b) transforming the left and right images captured in step a) to obtain a three-dimensional depth image that includes X×Y pixels, where X represents the number of the pixels in an image column direction, and Y represents the number of the pixels in an image row direction, each of the pixels having an individual disparity value;

c) transferring the three-dimensional depth image into two-dimensional image data relative to image row and disparity so as to generate a road function based on the two-dimensional image data;

d) transforming the three-dimensional depth image into an occupancy grid map relative to disparity and image column;

e) determining, based on a travel condition of the vehicle, a detecting area of the occupancy grid map to be detected;

f) estimating a cost estimation value corresponding to each of the disparity values on the same image column in the detecting area of the occupancy grid map using a cost function and the road function obtained in step c), and defining one of the disparity values on the same image column in the detecting area of the occupancy grid map whose the cost estimation value is maximum as an initial boundary disparity value for a corresponding one of all image columns in the detecting area of the occupancy grid map; and

g) optimizing the initial boundary disparity values for all the image columns in the detecting area of the occupancy grid map using an optimized boundary estimation function so as to obtain optimized boundary disparity values corresponding respectively to the initial boundary disparity values, and determining the free space in an image plane based on the optimized boundary disparity values using the road function obtained in step c).

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram illustrating a system that is configured for implementing the preferred embodiment of a method of detecting a free space in a direction of travel of a vehicle according to the present invention;

FIG. 2 is a flow chart of the preferred embodiment;

FIG. 3 is a schematic top view illustrating an example of the vehicle environment to be detected by the preferred embodiment;

FIGS. 4a and 4b illustrate respectively left and right images captured by an image capturing unit of the system from the vehicle environment of FIG. 3;

FIG. 5 shows a three-dimensional depth image transformed from the left and right images of FIGS. 4a and 4b;

FIG. 6 shows two-dimensional image data relative to image row and disparity and transformed from the three-dimensional depth image of FIG. 5;

FIG. 7 is a schematic top view showing different view regions capable of being detected by the preferred embodiment;

FIG. 8 shows an occupancy grid map relative to disparity and image column and transformed from the three-dimensional depth image of FIG. 5;

FIG. 9 shows optimized boundary disparity values in the occupancy grid map;

FIG. 10 shows a free space map determined based on the optimized boundary disparity values; and

FIG. 11 is a schematic view showing a combination of the free space map, and a base image associated with the left and right images of FIGS. 4a and 4b.

### DETAILED DESCRIPTION OF THE PREFERRED EMBODIMENT

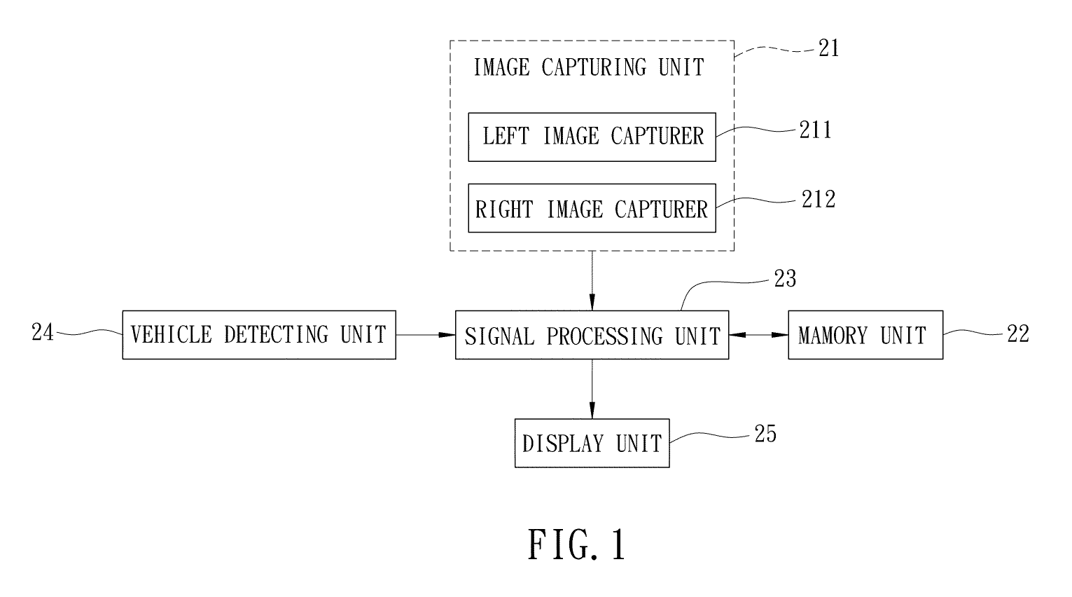

Referring to FIG. 1, a system configured for implementing the preferred embodiment of a method of detecting a free space in a direction (A) of travel of a vehicle 11 according to the present invention is shown to include an image capturing unit 21, a signal processing unit 23, a memory unit 22, a vehicle detecting unit 24, and a display unit 25. The system is installed to the vehicle 11.

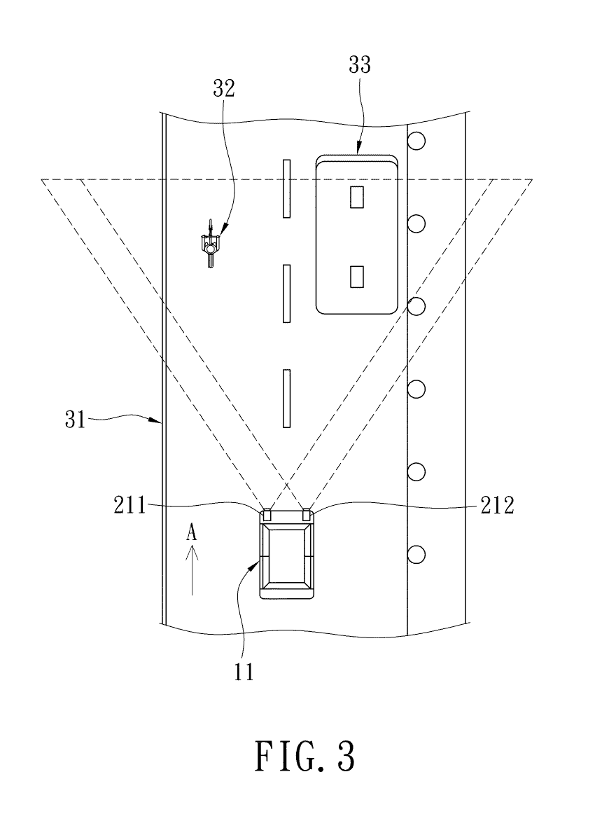

The image capturing unit 21 includes left and right image capturers 211, 212 adapted to be spacedly loaded on the vehicle 11 (see FIG. 3). Each of the left and right image capturers 211, 212 is operable to capture an image at a specific viewing angle. The image captured by each of the left and right image capturers 211, 212 has a resolution of X×Y pixels. In this embodiment, the left and right image capturers 211, 212 are cameras.

The signal processing unit 23 is connected electrically to the image capturing unit 21, and receives the images captured by the left and right images 3, 3′. In this embodiment, the signal processing unit 23 includes a main module mounted with a central processor.

The memory unit 22 is connected electrically to the signal processing unit 23 and stores the left and right images 3, 3′ therein. In this embodiment, the memory unit 22 includes a memory module. In other embodiments, the memory unit 22 and the signal processing unit 23 can be integrated into a single chip or a single main board that is incorporated into an electronic control system for the vehicle 11.

The vehicle detecting unit 24 is connected electrically to the signal processing unit 23. The vehicle detecting unit 24 is operable to output a detecting signal to the signal processing unit 23 in response to a travel condition of the vehicle 11. In this embodiment, the travel condition includes the speed of the vehicle 11, rotation of a steering wheel (not shown) of the vehicle 11, and operation of direction indicator (not shown) of the vehicle 11. The direction indicator includes a left directional light module and a right directional light module. As a result, the detecting signal is generated by the vehicle detecting unit 24 based on the speed of the vehicle 11, and one of rotation of the steering wheel of the vehicle 11 and operation of the direction indicator of the vehicle 11.

The display unit 25 is connected electrically to the signal processing unit 23, and is mounted on a dashboard (not show) of the vehicle 11 for displaying a base image associated with images captured respectively by the left and right images 3, 3′ thereon.

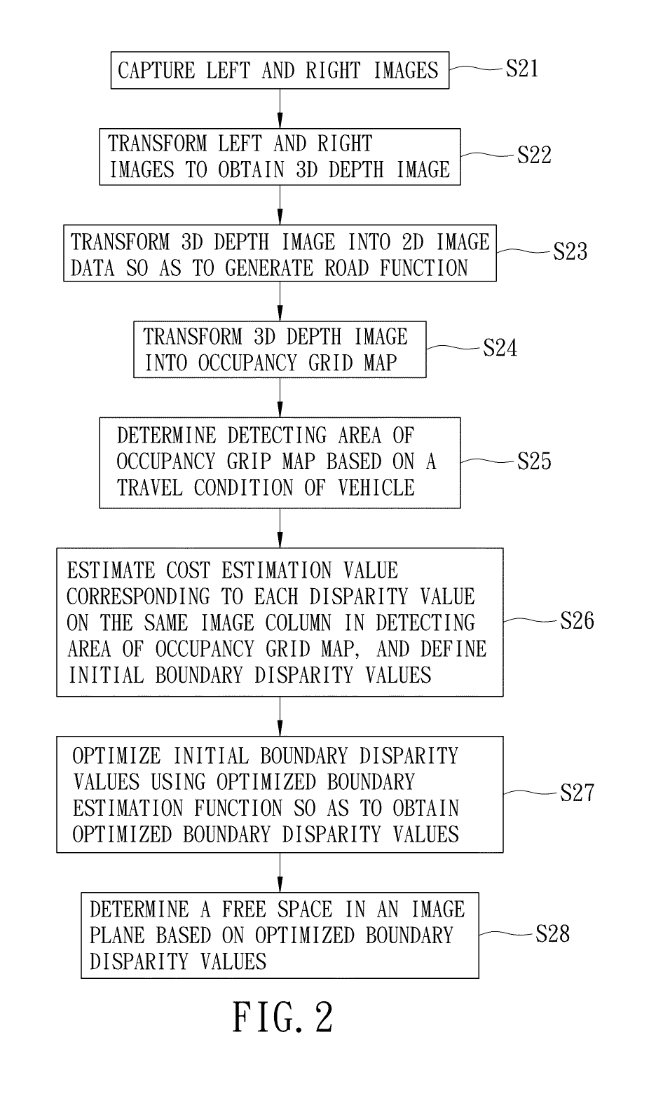

FIG. 2 illustrates a flow chart illustrating how the system operates according to the preferred embodiment of the present invention. FIG. 3 illustrates an example of the vehicle environment to be detected by the preferred embodiment, wherein there are a left wall 31, a motorcycle 32 and a bus 33 that are regarded as objects for the vehicle 11 to be detected. The following details of the preferred embodiment are explained in conjunction with the example of the vehicle environment of FIG. 3.

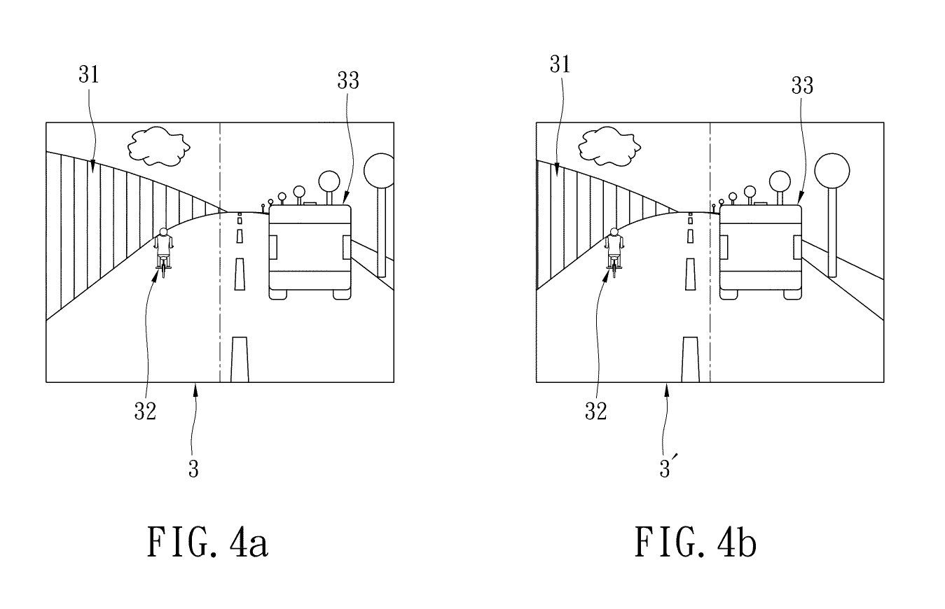

In step S21, the left and right image capturers 211, 212 of the image capturing unit 21 are operable to capture respectively left and right images 3, 3′, as shown in FIGS. 4a and 4b, at the specific viewing angle from the vehicle environment of FIG. 3 in the direction (A) of travel of the vehicle 11. In this example, the specific viewing angle is 30°, and each of the left and right images 3, 3′ includes 640×480 pixels. That is, there are 640 pixels in an image column direction, i.e., a horizontal direction, of the left and right images 3, 3′, and there are 480 pixels in an image row direction, i.e., a vertical direction, of the left and right images 3, 3′. The left and right images 3, 3′ captured by the image capturing unit 21 are stored in the memory unit 22.

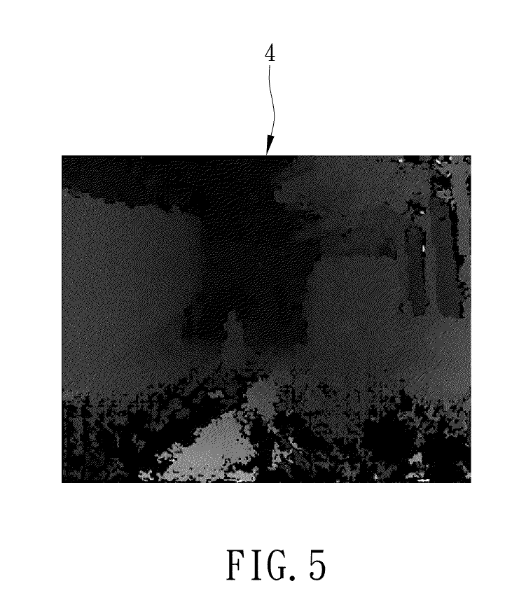

In step S22, the signal processing unit 23 is configured to transform the left and right images 3, 3′ captured in step S21 to obtain a three-dimensional depth image 4, as shown in FIG. 5. In this case, the three-dimensional depth image 4 has the same resolution as that of the left and right images 3, 3′, i.e., 640×480 pixels, wherein there are 640 pixels in the image column direction, and there are 480 pixels in the image row direction. Each pixel in the three-dimensional depth image 4 has an individual disparity value. In this embodiment, the three-dimensional depth image 4 is obtained by the signal processing unit 23 using feature point matching, but it is not limited to this.

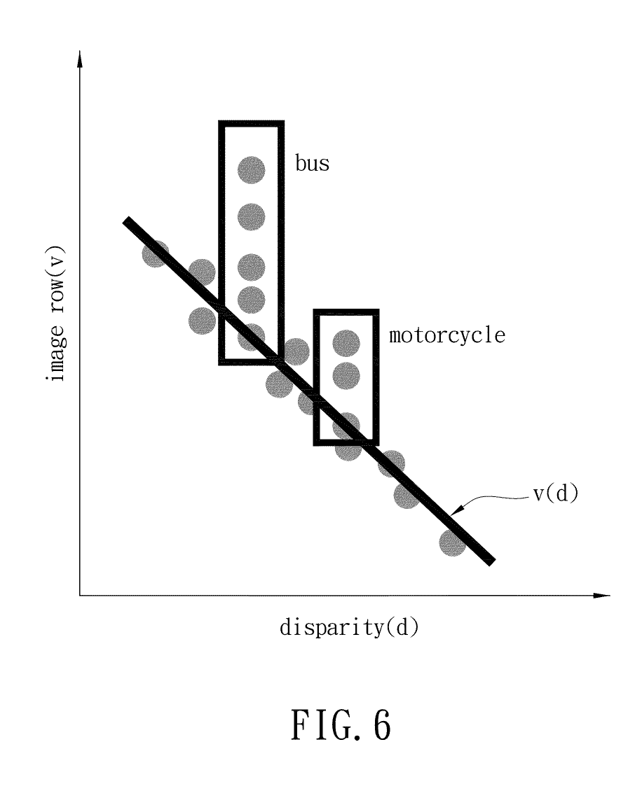

In step S23, the signal processing unit 23 is configured to transform the three-dimensional depth image 4 into two-dimensional image data relative to image row and disparity indicated by shadow points in FIG. 6. Then, the signal processing unit 23 is configured to generate a road function v(d) based on the two-dimensional image data using curve fitting. The road function v(d) (or d(v)) represents the relationship image row and disparity, and can be expressed as following:

$$v ( d ) = v = d \times A + B ( or d ( v ) = d = \frac{v - B}{A} )$$

where A and B are respectively an obtained road parameter and an obtained road constant. In this example, the road parameter (A) is 0.6173, and the road constant (B) is 246.0254.

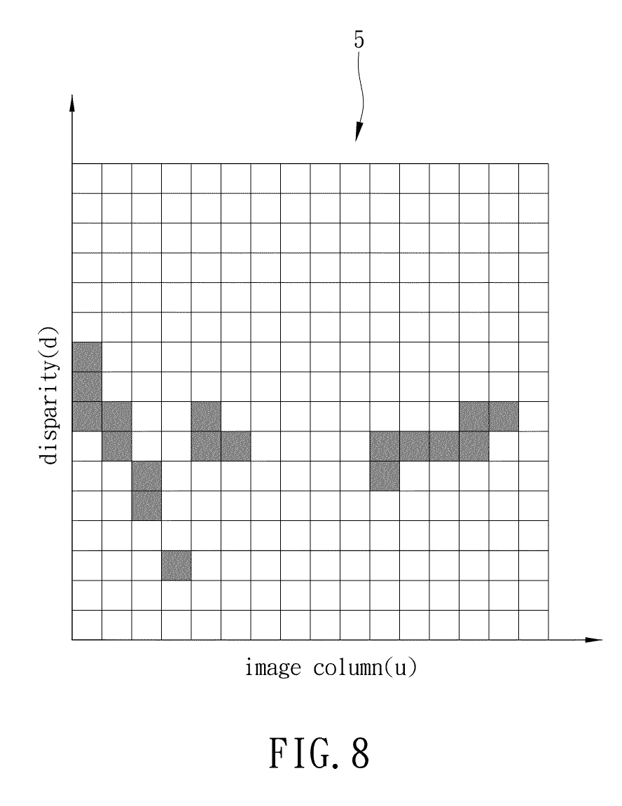

In step S24, The signal processing unit 23 is configured to transform the three-dimensional depth image 4 into an occupancy grid map 5 relative to disparity and image column, as shown in FIG. 8. In this case, the occupancy grid map 5 has 640 image columns in the image column direction. The occupancy grip map 5 includes two-dimensional image data, as indicated by shadow grids in FIG. 8.

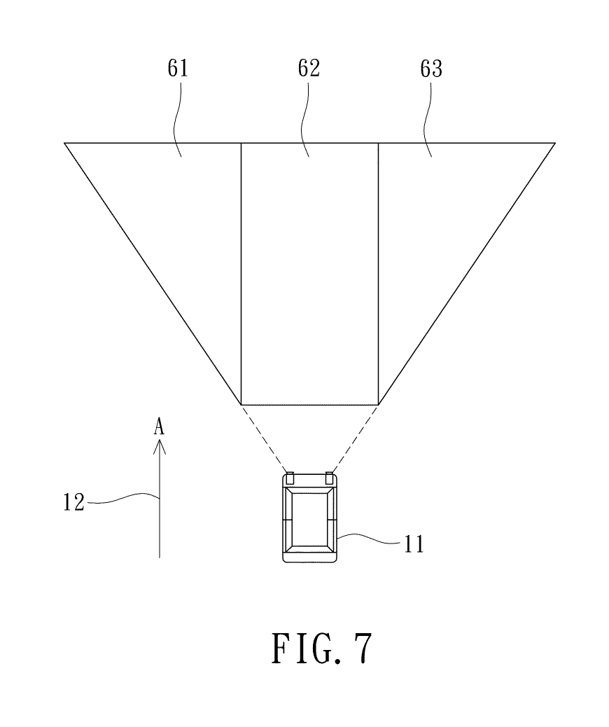

In step S25, the signal processing unit 25 is configured to determine, base on the detecting signal from the vehicle detecting unit 24, a detecting area of the occupancy grid map 5 to be detected. FIG. 7 illustrates different viewing regions 61 62, 63 capable of being detected by the preferred embodiment. When the speed of the vehicle 11 is higher than a predetermined speed, such as 30 km/hr, while the steering wheel is not rotated, the detecting signal indicates that the viewing region 62 is to be detected. When the speed of the vehicle 11 is higher than the predetermined speed while the steering wheel is clockwise rotated (or the right directional light is activated), the detecting signal indicates that the viewing regions 62, 63 are to be detected. When the speed of the vehicle 11 is higher than the predetermined speed while the steering wheel is counterclockwise rotated (or the left directional light is activated), the detecting signal indicates that the viewing regions 61, 62 are to be detected. When the speed of the vehicle 11 is not higher than the predetermined speed while the steering wheel is not rotated, the detecting signal indicates that the viewing regions 61, 62, 63 are to be detected. In this example, the speed of the vehicle 11 is lower than the predetermined speed, and the steering wheel is not rotated. Thus, the detecting signal indicates that the viewing regions 61, 62, 63 are to be detected. In other words, the detecting area determined by the signal processing unit 23 based on the detecting signal is identical to the occupancy grid map 8.

In step S26, the signal processing unit 23 is configured to estimate a cost estimation value C(u,d) corresponding to each of the disparity values (d) on the same image column (u) in the occupancy grid map 5 using a cost function and the road function v(d). The cost function can be expressed as following:

C(u,d)=ω₁×Object(u,d)+ω₂×Road(u,d)

where ω₁ is an object weighting constant, and ω₂ is a road weighting constant. To obtain a superior detection result, in this example, the object weighting constant ω₁ and the road weighting constant ω₂ are 30 and 50, respectively, but they are not limited to this. Object(u,d) represents a function associated with variation of the disparity values from the image capturing unit 21 to one object, and can be expressed as following:

Object(u,d)=Σᵥ₌ᵥ_{ₘᵢₙ}^{v(d)}ω(d_{u,v}−d)

Where vₘᵢₙ=0, ω(d_{u,v}−d) represents a binary judgment function, and is defined as following:

ω(d_{u,v}−d)=1, when |d_{u,v}−d|<D

ω(d_{u,v}−d)=0, when |d_{u,v}−d|≧D

where D is a predetermined threshold. In this example, the predetermined threshold (D) is 20. Similarly, Road(u,d) represents a function associated with variation of the disparity values from said one object to the rear, and can be expressed as following:

Object(u,d)=Σ_{v=v(d)}^{v}^{ₘₐₓ}ω(d_{u,v}−d(v))

where vₘₐₓ represents an upper most column in of the three-dimensional depth image 4. Then, the signal processing unit 23 is configured to define one of the disparity values on the same image column in the occupancy grid map 5 whose the cost estimation value is maximum as an initial boundary disparity value I(u) for a corresponding one of all image columns in the occupancy grid map 5. Therefore, the initial boundary disparity value I(u) for each image column in the occupancy grid map 5 can be expressed as following:

I(u)=max_{d}{C(u,d)}

Thus, the initial boundary disparity values for all the image columns in the occupancy grid map 5 can constitute a curved line (not shown). In order to reduce the impact of noise on the detection results, smoothing of the curved line is required.

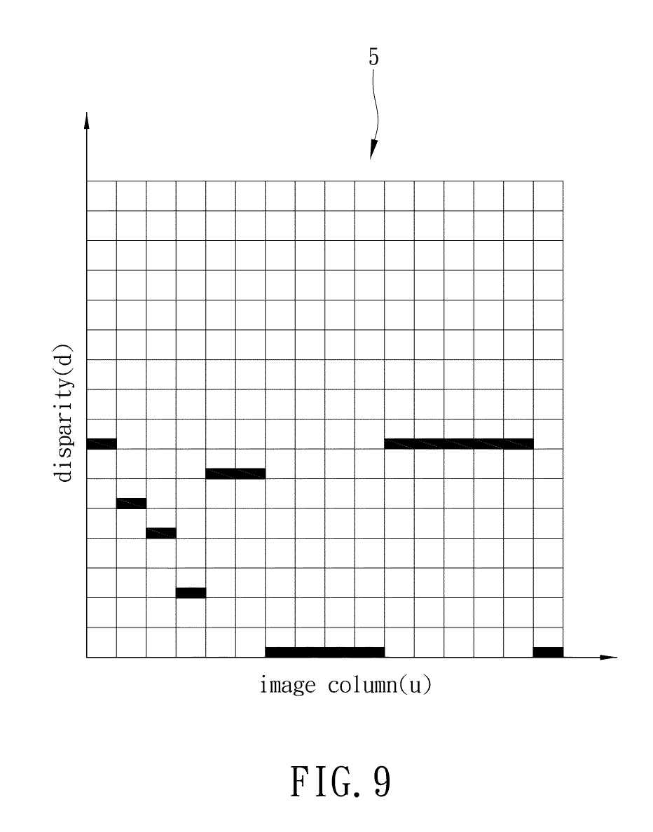

In step S27, the signal processing unit 23 is configured to optimize the initial boundary disparity values for all the image columns in the occupancy grid map 5 using an optimized boundary estimation function so as to obtain optimized boundary disparity values corresponding respectively to the initial boundary disparity values. The optimized boundary disparity values corresponding respectively to all the image columns are illustrated in FIG. 9. In this embodiment, the optimized boundary estimation function can be expressed as following:

E(u,d)=C(u,d)+Cs(u,d)

where E(u,d) represents a likelihood value corresponding to each of the disparity values on the same image column in the occupancy grid map 5, and Cs(u,d) represents a smoothness value corresponding to each of the disparity values on the same image column in the occupancy grid map 5. Cs(u,d) can be expressed as following:

Cs(u,d)=max{C(u−1,d),C(u−1,d−1)−P₁,C(u−1,d+1)−P₁, maxC(i−1,Δ)−P₂}

where P₁ is a first penalty constant, and P₂ is a second penalty constant greater than the first penalty constant (P₁). For example, preferably, when P₁=3, and P₂=10, the superior detection result can be obtained. As a result, the optimized boundary disparity value O(u) corresponding to each image column can be expressed as following:

O(u)=max_{d}{E(u,d)}

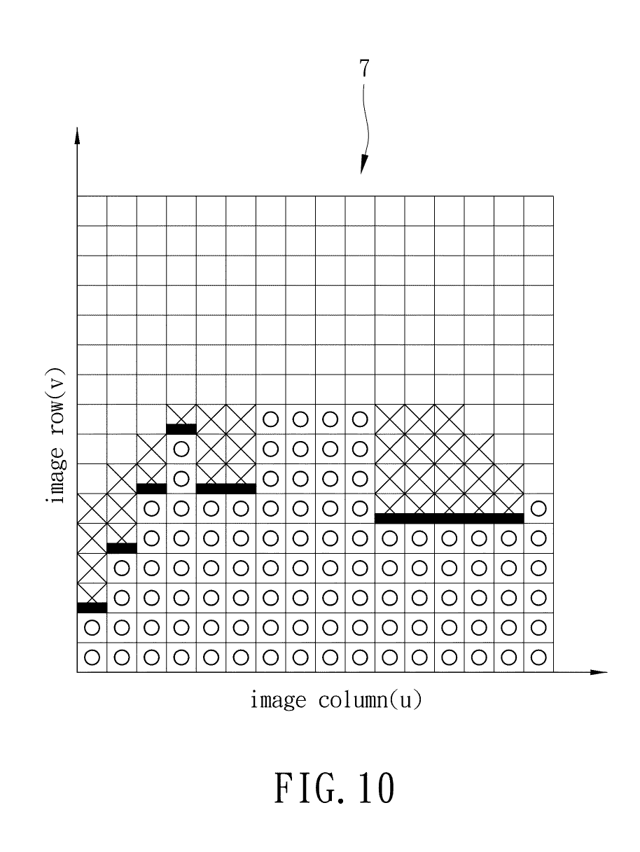

In step S28, the signal processing unit 23 is configured to determine the free space in an image plane based on the optimized boundary disparity values using the road function v(d). FIG. 10 illustrates a free space map 7 with respect to the image plane that is determined based on the optimized boundary disparity values, wherein the free space is defined by a plurality of boundary bars, and includes a plurality of grid areas indicated by symbols of “O”, and grid areas indicated by symbols of “X” represent different object regions, such as the side wall, the motorcycle and the bus in this example.

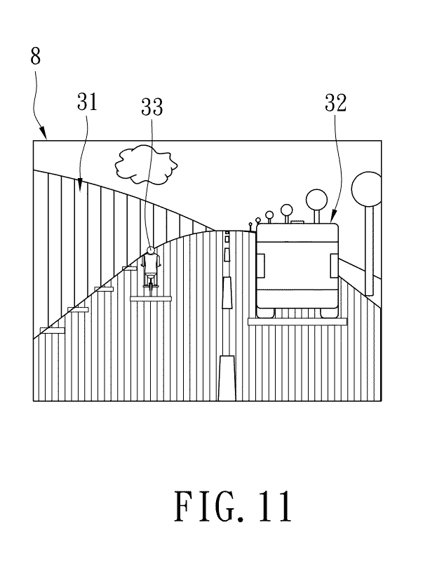

Thereafter, the free space map 7 can be combined with the base image associated with the left and right images 3, 3′ to form a combination image as shown in FIG. 11. The combination image is displayed on the display unit for reference. In addition, the free space detected by the method of the present invention can be used by an automatic driving system to adjust the direction of travel of the vehicle 11 during travelling or parking of the vehicle 11.

In sum, since the free space detection method of the present invention detects each object boundary using disparity values to obtain the free space, calculation burden for determination of the optimized boundary disparity values is relatively low compared to image comparison between the transformed left images and the right image for each area in the prior art. Therefore, the free space detection can be completed within a short predetermined time period, for example one second, thereby achieving real-time detection.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A system for detecting a free space in a direction of travel of a vehicle, comprising:
an image capturing unit including left and right image capturers adapted to be spacedly loaded on the vehicle for capturing respectively left and right images from the vehicle environment in the direction of travel of the vehicle;
a signal processing unit connected electrically to said image capturing unit for receiving the left and right images therefrom, said signal processing unit being operable to
transforming the left and right images captured by said first and second image capturing units to obtain a three-dimensional depth image that includes X×Y pixels, where X represents the number of the pixels in an image column direction, and Y represents the number of the pixels in an image row direction, each of the pixels having an individual disparity value,
transforming the three-dimensional depth image into two-dimensional image data relative to image row and the disparity so as to generate a road function based on the two-dimensional image data,
transforming the three-dimensional depth image into an occupancy grid map relative to disparity and image column,
determining, based on a travel condition of the vehicle, a detecting area of the occupancy grid map to be detected,
estimating a cost estimation value corresponding to each of the disparity values on the same image column in the detecting area of the occupancy grid map using a cost function and the road function, and defining one of the disparity values on the same image column in the detecting area of the occupancy grid map whose the cost estimation value is maximum as an initial boundary disparity value for a corresponding one of all image columns in the detecting area of the occupancy grid map, and
optimizing the initial boundary disparity values for all the image columns in the detecting area of the occupancy grid map using an optimized boundary estimation function so as to obtain optimized boundary disparity values corresponding respectively to the initial boundary disparity values, and determining the free space in an image plane based on the optimized boundary disparity values using the road function.

2. The system as claimed in claim 1, wherein the three-dimensional depth image is obtain by said signal processing unit using stereo matching algorithm.

3. The system as claimed in claim 1, wherein the road function is generated by said signal processing unit based on the two-dimensional image data using curve fitting.

4. The system as claimed in claim 1, wherein the travel condition of the vehicle includes the speed of the vehicle, rotation of a steering wheel of the vehicle, and operation of direction indicator of the vehicle, said system further comprising a vehicle detecting unit connected electrically to said signal processing unit, said vehicle detecting unit being operable to generate a detecting signal based on the speed of the vehicle, and one of rotation of the steering wheel of the vehicle and operation of the direction indicator of the vehicle, and outputting the detecting signal to said signal processing unit such that said signal processing unit determines the detecting area of the occupancy grid map based on the detecting signal from said vehicle detecting unit.

5. A method of detecting a free space in a direction of travel of a vehicle, comprising the steps of:
a) capturing respectively left and right images from the vehicle environment in the direction of travel of the vehicle;
b) transforming the left and right images captured in step a) to obtain a three-dimensional depth image that includes X×Y pixels, where X represents the number of the pixels in an image column direction, and Y represents the number of the pixels in an image row direction, each of the pixels having an individual disparity value;
c) transforming the three-dimensional depth image into two-dimensional image data relative to image row and disparity so as to generate a road function based on the two-dimensional image data;
d) transforming the three-dimensional depth image into an occupancy grid map relative to disparity and image column;
e) determining, based on a travel condition of the vehicle, a detecting area of the occupancy grid map to be detected;
f) estimating a cost estimation value corresponding to each of the disparity values on the same image column in the detecting area of the occupancy grid map using a cost function and the road function obtained in step c), and defining one of the disparity values on the same image column in the detecting area of the occupancy grid map whose the cost estimation value is maximum as an initial boundary disparity value for a corresponding one of all image columns in the detecting area of the occupancy grid map; and
g) optimizing the initial boundary disparity values for all the image column coordinates in the detecting area of the occupancy grid map using an optimized boundary estimation function so as to obtain optimized boundary disparity values corresponding respectively to the initial boundary disparity values, and determining the free space in an image plane based on the optimized boundary disparity values using the road function obtained in step c).

6. The method as claimed in claim 5, wherein, in step b), the three-dimensional depth image is obtained using stereo matching algorithm.

7. The method as claimed in claim 5, wherein, in step c), the road function is generated based on the two-dimensional image data using curve fitting.

8. The method as claimed in claim 5, wherein, in step e), the travel condition of the vehicle includes the speed of the vehicle, rotation of a steering wheel of the vehicle, and operation of direction indicator of the vehicle such that the detecting signal is generated based on the speed of the vehicle, and one of rotation of the steering wheel of the vehicle and operation of the direction indicator of the vehicle.
